(19) United States
(12) Patent Application Publication
(10) Pub. No.: US 2023/0366260 A1
(43) Pub. Date: Nov. 16, 2023

(54) DOOR PROTECTION PLATES

(71) Applicant: ASSA ABLOY Accessories and Door Controls Group Inc., New Haven, CT (US)

(72) Inventors: Douglas Thompson, Somerset, PA (US); Paul Smith, Berlin, PA (US)

(73) Assignee: ASSA ABLOY Accessories and Door Controls Group, Inc., New Haven, CT (US)

(21) Appl. No.: 18/122,852

(22) Filed: Mar. 17, 2023

Related U.S. Application Data
(60) Provisional application No. 63/341,215, filed on May 12, 2022.

(51) Int. Cl. E06B 7/28

(52) U.S. Cl. CPC E06B 7/28

(57) ABSTRACT

The inclusion of a galvanneal material with a door protection plate and methods of manufacturing thereof are disclosed. In some embodiments, a door protection plate may include a substrate, a plurality of holes, a first coating of zirconium polymer, and a second powder coating. Incorporating a galvanneal material as a first coating provides a conductive surface for adhesion of the powder coating, and additional corrosion prevention for the door protection plate.

### FIELD

Disclosed embodiments are related to door protection plates and the manufacturing processes thereof.

### BACKGROUND

Door protection plates are widely used in an environment where damage prevention for a door due to impact is needed. To preserve the longevity of the door, the door protection plate is conventionally made of a durable material such as stainless steel or other non-ferrous materials. Ferrous materials are typically not used as they could come in contact with moisture and cleaning solutions, which could result in corrosion. Some applications prefer a kick plate to be treated with a coloring agent such as powder coat to get away from the industrial look of purely metal components. Given the risks of potential corrosion even these colored kick plates are typically made out of expensive non-ferrous materials. The risk predominantly stems from areas of the material that are not treated with an anti-corrosive material such as zinc which is applied through a durable galvanization process. While this protects the largest surface areas, it does not protect areas where the galvanized plate has been punched, drilled, or sheared exposing surfaces that do not have the protective zinc applied to them. Powder coating the sheared edges can be difficult resulting in areas left uncovered, or the powder coat can become fractured from the force of a screw head fastening it to the door. These undercoated or fractured areas present opportunities for corrosive agents to attack the now exposed non-ferrous materials. Similarly, other edges of the plate may experience abrasion during installation.

### SUMMARY

In one embodiment, a door protection plate includes a substrate; a plurality of holes disposed in the substrate; and a zirconium polymer coating disposed on an outside surface of the substrate. A powder coating disposed on an outside surface of the zirconium polymer coating.

In another embodiment, a method of manufacturing a door protection plate includes cutting a substrate to a desired shape; creating a plurality of holes through the substrate; rinsing the substrate with water; applying a zirconium polymer to the surface of the substrate; allowing the zirconium polymer coated substrate to drip dry; rinsing an excess amount of zirconium polymer to establish a desired amount of zirconium polymer disposed on the surface of the substrate; drying the substrate; applying a powder coating to the surface of the zirconium polymer coated substrate; and curing the door protection plate in an oven.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a representative view of a door protection plate fastened to a door;

FIG. 2 is a perspective view showing the layering of coatings applied to a substrate; and

FIG. 3 shows, according to some embodiments, a flow chart for a method of manufacturing a door protection plate.

### DETAILED DESCRIPTION

During the installment of door protection plates used to increase the longevity of a door's life, a powder coating designed to fight corrosion may be applied in the manufacturing process. The application of these powder coatings can be labor and cost intensive. A common material used for these plates is stainless steel because of its aesthetically pleasing appeal and it can be sanitized easily. Stainless steel is corrosion resistant on its own; however, if a less industrial appearance is desirable, a powder coat may be applied. Currently, the process consists of removing a plastic film from precut metal, sanding the metal to remove remnants of the plastic coating to ensure proper adhesion, applying the powder coating, heating the metal to cure the coating, cooling the metal, and then packaging the metal to be ready for application to a door. Standard practice for the application of the powder coating includes electrically grounding a substrate, then using an electrostatic spray gun to spray electrically charged particles that adhere to the grounded surface of the substrate.

Further, these powder coatings are susceptible to shearing when fastening a door protection plate to a door. Screws and other objects come into abrasive contact which may leave the ferrous substrate exposed, and therefore highly susceptible to corrosion.

In view of the above, the Inventors have recognized the benefits associated with using a galvanneal material as a substrate, such as steel treated with a thin layer of zinc, instead of stainless steel as the substrate. Galvanneal material is much cheaper as compared to stainless steel and requires less preparation when applying a powder coat. When manufacturing a door protection plate with galvanneal material, creating the fastening holes can eliminate the thin coating of zinc in that area leaving the ferrous material exposed. To overcome this, a thin layer of zirconium polymer is applied to the entire door protection plate to ensure all areas of the plate are protected. Accordingly, should the powder coat become sheared or cracked during handling and/or installation, an additional protective layer provided by the zirconium polymer will act as further protection for the door protection plate.

In addition, the Inventors have found that using galvanneal material as the substrate of the door protection plate eliminates the steps of removing the plastic coating from the metal and sanding the metal before application of the powder coat. When using other metals as a substrate, they typically require an oil based rust inhibitor or plastic film to prevent initial corrosion or scratching the finish before the powder coat is applied. In this regard, the galvanneal substrate would not typically be supplied by the material vendor with a protective plastic film such that there would be no need to remove any protective plastic film. An oil based rust inhibitor would also not need to be used, and later chemically removed before powder coating. Therefore, by using the galvanneal substrate, labor costs can be reduced because the step of removing a plastic coating or oil based inhibitor is obviated. Additionally, like stainless steel, the galvanneal material disclosed herein is electrically conductive, and therefore may be grounded, allowing adherence of electrically charged particles when powder coating.

In some embodiments, a door protection plate may include a galvanneal substrate with a plurality of holes, a first coating, and a second coating. The first coating may be a thin layer of zirconium polymer, and the second coating may be a powder coating. This zirconium polymer coating may be configured to provide corrosion protection to any exposed ferrous material, and withstand abrasion from other objects, keeping the galvanneal substrate sealed in a layer of corrosion protectant. The second coating may be a powder coating configured to provide additional corrosion protection, and fulfill aesthetic requirements.

As used herein, corrosion protectant may refer to a material containing natural elements that combat the degrading effects of elements such as water and cleaning solutions that frequently come in contact with a door protection plate.

In some embodiments, a zirconium polymer coating can vary in thickness and concentration. The coating may be designed to withstand abrasion from the use of fasteners, or other scenarios capable of causing wear to a door protection plate. Appropriate parameters that may be considered when selecting a thickness of a coating may include, but are not limited to, environment a door protection plate is located, intensity of wear expected, and the area of wear expected in relation to the door protection plate.

In some embodiments, a thickness of the zirconium polymer coating may be greater than or equal to 0.02 mm. 0.03 mm, 0.05 mm, 0.1 mm, 0.5 mm, 1 mm, 2 mm, 3 mm, or any other suitable thickness or range therebetween. In some embodiments, the thickness of the zirconium polymer coating may be less than or equal to 3 mm, 2 mm, 1 mm, 0.1 mm, 0.05 mm, 0.03 mm or any other suitable thickness or range therebetween. Of course, it should be understood that other thicknesses and ranges of thicknesses, both greater than and less than those noted above, are also contemplated as the disclosure is not so limited.

A first coating of a door protection plate may be made of an appropriate material capable of providing a satisfactory amount of corrosion protection. A first coating may consist of a zirconium compound mixed with a polymeric material to form a zirconium polymer. This polymeric material allows for easy application when covering untreated edges and fastening holes of the galvanneal substrate. Further, the polymeric material includes a curing component to chemically harden and provide durability.

In some embodiments, a door protection plate may be mechanically joined to a door by a number of fasteners. Holes are drilled through the ferrous substrate near the perimeter of the door protection plate and are configured to receive the fasteners such as screws to mount the door protection plate to a desired area of a door. These holes may become regions in the door protection plate where coating may shear away, exposing the substrate. In one embodiment, a greater amount of zirconium polymer may be applied to this area to provide a stronger barrier of corrosion protectant between the ferrous substrate and the elements that cause corrosion as compared to the amount of zirconium polymer applied to other areas of the substrate. This may be accomplished by subjecting the region of the substrate having the holes with an additional application or applications of the zirconium polymer.

It should be understood that a first coating of a door protection plate may include any combination of appropriate thickness of the zirconium polymer coating, finish of the zirconium polymer coating, and concentration of zirconium compound capable of providing a desired protection against corrosion. Further, the thickness of the coating and the concentration of the zirconium compound within the polymer may also vary to accommodate different applications and operational preferences. For example, in some embodiments, a door protection plate may be configured to have a thick coating with a heavily concentrated zirconium compound to resist wear from heavy abrasion and combat intense, corrosive environments. Of course, in one embodiment, the zirconium polymer may be sprayed on in a uniform pattern and/or thickness across the entirety of the part. Contrastingly, in other embodiments, the assembly may be configured to have a thin coating with a less concentrated zirconium compound to efficiently use materials and meet the level of corrosion protection desired. The desired dimensions of a first coating of zirconium polymer for a door protection plate may be determined based on the desired functionalities as well as appropriate parameters including, but not limited to, the surrounding environment, the intensity of abrasion expected, as well as any number of other factors.

The disclosed process of using a galvanneal substrate, a first coating of zirconium polymer, and a second coating of powder coating may be used in any number of different applications. For example, any ferrous material prone to corrosion where corrosion protection is desirable such as metal doors, door frames, window frames and sills, door locks and components, exit devices, door rails, door closers, and many others.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

FIG. 1 shows a schematic view of an embodiment of a door protection plate 1 fastened to a lower portion of the door 2. In the embodiment shown, the door protection plate is rectangular, though any other suitable shape may be employed. A plurality of holes 3 sized to accept fasteners, such as screws, disposed around the perimeter just inside the outer edge of the door protection plate 1 so that door protection plate 1 can be securely mounted to the door.

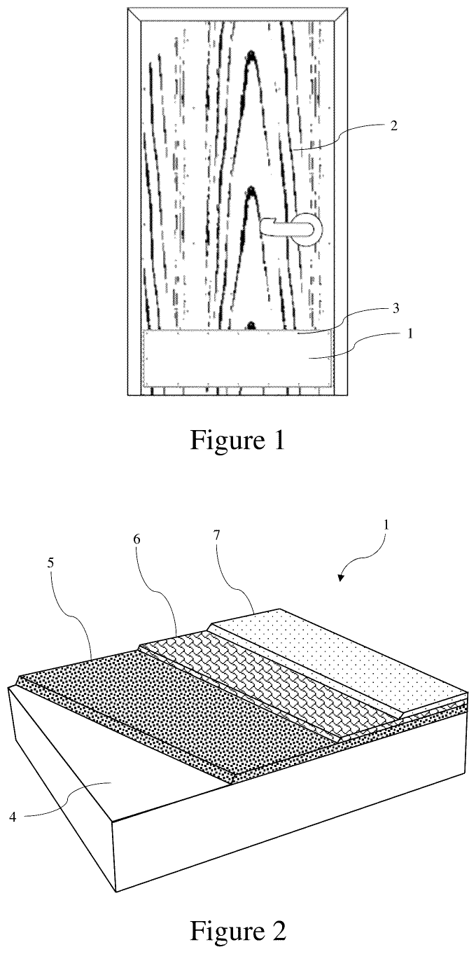

FIG. 2 shows a perspective view of door protection plate 1 that includes a ferrous substrate 4 treated with a thin layer of zinc 5, a zirconium polymer coating 6 and a powder coating 7. In this exemplary embodiment, the starting material is a galvanneal material made of a ferrous substrate 4 such as steel treated with a thin layer of zinc 5 on the surface. A first coating, that is a coating of zirconium polymer 6, is applied around all surfaces of the substrate 4, including the surfaces defining the plurality of holes 3 and all edges of the plate. A second coating, such as powder coating 7, is applied directly on top of the first coating of zirconium polymer 6. The powder coating is also applied around all surfaces of the zirconium polymer coated substrate 4, including the surfaces defining the plurality of holes 3 and all edges of the door protection plate 1.

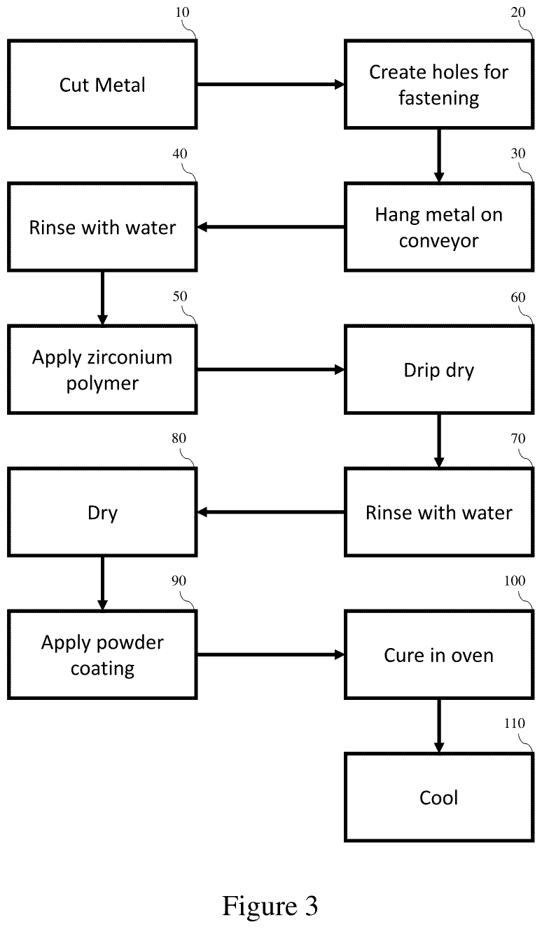

FIG. 3, according to some embodiments, shows a flowchart for a process of manufacturing a door protection plate 1. In a first block 10, the process may begin with a piece of galvanneal material consisting of a ferrous substrate 4 treated with a thin layer of zinc 5. This galvanneal material is cut to a desired shape, often rectangular as depicted in door protection plate 1 of FIG. 1, though other desired shapes may be employed. Next, in the second block 20, a plurality of holes may be formed in the cut substrate. An example of the holes may be seen in the plurality of holes 3 disposed around the perimeter of door protection plate 1 in FIG. 1.

When the ferrous substrate 4 is ready to be coated, as shown in block 30 of the flow chart, the substrate may be hung on a conveyor belt to begin the coating process. Next, as shown in block 40, the substrate may be rinsed with water to remove any dirt, or other debris, that could interfere with the quality of the coating applied to the surface of the substrate. When the substrate has been rinsed, the first coating of a zirconium polymer may be applied directly to the outer surface of the shape, as shown in block 50. Once the zirconium polymer has been applied, the next step of the process, as shown in block 60, may be to allow the zirconium polymer layer to dry. Next, in block 70, the coated door protection plate may be rinsed to remove any excess zirconium polymer that may interfere with the final coating. Once the zirconium polymer coating 5 is rinsed and the appropriate thickness remains, the door protection plate 1 may be dried as shown in block 80. As the layer of zirconium polymer 6 dries, it begins to cure allowing a chemical reaction to occur that hardens the zirconium polymer 6 to resist abrasion and enhance durability.

Following the curing of the zirconium polymer coating 6, the coated substrate may be ready for a powder coating 7, as shown in block 90. At least the surface of the coated substrate may be electrically grounded for electrically charged particles to be sprayed onto the coated substrate. As the electrically charged particles contact the grounded surface of the coated substrate, the charged particles adhere to the surface of the coated substrate. Once the powder coating 7 is applied, as shown in block 100, the door protection plate 1 may be put into an oven for curing. The curing process allows the powder coat to chemically harden and resist abrasive ware, similar to the curing process of the zirconium polymer coating 5 mentioned above. Once cured, the powder coating 7 will be disposed relatively evenly throughout the entire surface of the zirconium polymer coating, as shown in FIG. 2. Next, as shown in block 110, the door protection plate 1 may be cooled. Once the door protection plate 1 is ready to handle, it may be assembled or packaged and shipped.

Further referring to FIG. 3, in one embodiment, the process may begin with block 20 where holes are created in the substrate and thereafter the metal is cut. Further, in one embodiment, between blocks 30 and 40, a further process of applying soap to the substrate may be employed. Thereafter at block 40 the substrate is rinsed. Further, in one embodiment after block 50, the process may include rinsing the applied zirconium polymer. In one embodiment, they zirconium polymer coating may be less than 1 mil (0.001 inches or 0.0254 mm) thick.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A door protection plate comprising:
a substrate;
a plurality of holes disposed in the substrate;
a first coating disposed on an outside surface of the substrate, wherein the first coating is a zirconium polymer; and
a second coating disposed on an outside surface of the first coating, wherein the second coating is a powder coating.

2. The door protection plate of claim 1, wherein the substrate is galvanneal material.

3. The door protection plate of claim 1, wherein the plurality of holes are disposed around a perimeter of the door protection plate.

4. The door protection plate of claim 1, wherein the plurality of holes are configured to enable fastening the door protection plate to a door.

5. The door protection plate of claim 1, wherein the first coating is configured to provide corrosion protection.

6. The door protection plate of claim 1, wherein the second coating is configured to provide a chemical protection.

7. The door protection plate of claim 1, wherein the first coating and the second coating are disposed on an edge of the door protection plate and inside the plurality of holes.

8. A method of manufacturing a door protection plate, the method comprising:
cutting a substrate to a desired shape;
creating a plurality of holes through the substrate;
rinsing the substrate with water;
applying a first coating to the surface of the substrate, wherein the first coating comprises zirconium polymer;
allowing the zirconium polymer coated substrate to drip dry;
rinsing an excess amount of zirconium polymer to establish a desired amount of zirconium polymer disposed on the surface of the substrate;
drying the substrate;
applying a powder coating to the surface of the zirconium polymer coated substrate; and
curing the door protection plate in an oven.

9. The method of claim 8, wherein cutting a substrate to a desired shape comprises cutting a galvanneal material substrate to a desired shape.

10. The method of claim 8, wherein creating a plurality of holes through the substrate comprises creating the plurality of holes around the perimeter of the door protection plate.
